(19) United States
(12) Patent Application Publication
(10) Pub. No.: US 2005/0063679 A1
(43) Pub. Date: Mar. 24, 2005

(54) Recordable video player applied in real time multimedia communication

(76) Inventors: Ching-Ho Huang, Hsinchu (TW); Pin-Huang Hsin, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/919,040

(22) Filed: Aug. 16, 2004

(30) Foreign Application Priority Data
Sep. 19, 2003 (TW) 92126027

(51) Int. Cl. H04N 5/76; H04N 5/225

(52) U.S. Cl. 386/117; 386/125

(57) ABSTRACT

A recordable video player is applied to Real Time Multimedia Communication. An image and audio capture device and an Internet I/O port are added to the recordable video player. The image and audio capture device is used to capture the user's image and audio, and the Internet I/O port is used in multimedia signal input and output transfer. By the usage of the encoder and decoder inside the recordable video player that connected to an image and audio capture device and an Internet I/O port, the goal of Real Time Multimedia Communication is reached.

### BACKGROUND OF THE INVENTION

(1) Field of the Invention

The invention relates to a recordable video player, and more particularly to a recordable video player applied in real time multimedia communication.

(2) Description of the Prior Art

Recently, optical disks as efficient communicative storage means have been widely applied to be feasible to most electronic devices such as office facilities, computers, entertainment equipments, industrial control boxes and so on. For reading and/or writing the optical disks, a disk drive as a recordable video player is common for the domestic device to manage the information stored or to be stored in the optical disk.

Referred to FIG. 1, a block diagram of a conventional recordable video player is illustrated. Wherein, the recordable video player 100 comprises a processor 10, an encoder 20, a decoder 30, a recorder 40, a displayer 50 and a AV (Audio-Video) transmission line 60.

Generally speaking, there are two main functions in a recordable video player. One is to record the video signal transmitted from the AV transmission line 60, and the other is to reproduce the encoded data string recorded in the recording medium such as an optical disk, a hard disk or a memory.

When the function of recording the video signal transmitted from the AV transmission line 60 is active, the processor 10 transmits the video signal received from the AV transmission line 60 to the encoder 20. Then, the encoder 20 encodes the video signal into a encoded data string as Motion Picture Experts Group (for example, MPEG 1, MPEG2 and MPEG4). Further, the encoded data string encoded by the encoder 20 is transmitted to the recorder 40 and recorded by the recorder 40. Wherein, the recorder 40 can be a DVD or VCD recordable drive, a hard disk or a memory. Moreover, the users can watch the video showing on the displayer 50 and the video signal can be recorded in the mean while by connecting the AV transmission line 60 to the displayer 50 directly.

Additionally, when the function of reproducing the encoded data string recorded in the recording medium is active, the processor 10 transmits the encoded data string to the decoder 30 from the recorder 40. Then, the decoder 30 decodes the encoded data string into a displaying signal and transmits the displaying signal to the displayer 50.

Though the recordable video player is popular in the home entertainment, the functions of the recordable video player are limited in recording and reproducing as mentioned above. If the recordable video player is well used by developing various functions, it will be helpful and convenient for users or even the industries.

### SUMMARY OF THE INVENTION

Accordingly, it is an object of the present invention to provide a recordable video player which can be applied in the real time multimedia communication and thus can save the cost for the video conference.

In accordance with the present invention, the recordable video player has an image and audio capture device for capturing the desired image and audio in time. Then, the data string of the captured image and audio is transmitted to the encoder in the recordable video player and the encoder encodes the data string of the captured image and audio into an output encoded data string.

In the present invention, the output encoded data string is transmitted to an internet I/O port and then transmitted to the remote users by internet. Accordingly, the remote users can further receive an input encoded data by a recordable video player applied in the real time multimedia communication through an internet I/O port and the input encoded data is transmitted to an decoder inside the recordable video player.

In the present invention, the decoder receives the input encoded data and decodes the input encoded data into a displaying signal. Then, the displaying signal is transmitted to a displayer. As a result, the image and audio of the remote users can be shown on the displayer by the recordable video player.

All these objects are achieved by the recordable video player applied in the real time multimedia communication described below.

### BRIEF DESCRIPTION OF THE DRAWINGS

The present invention will now be specified with reference to its preferred embodiment illustrated in the drawings, in which:

FIG. 1 is a block diagram of a conventional recordable video player;

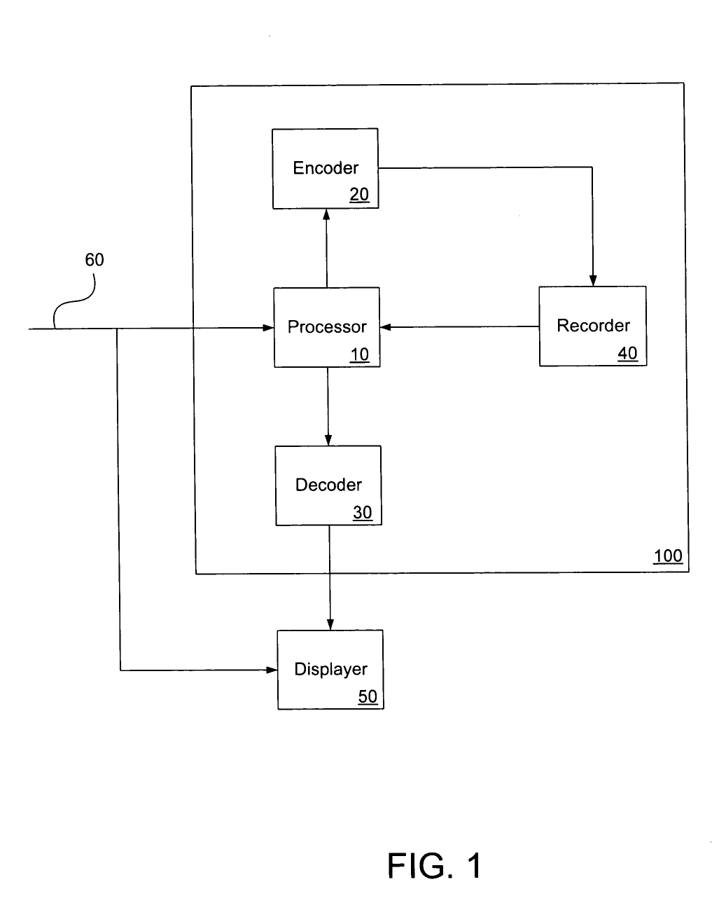

FIG. 2 is a block diagram of a recordable video player applied in the real time multimedia communication in accordance with the present invention;

### DESCRIPTION OF THE PREFERRED EMBODIMENTS

The invention disclosed herein is directed to a recordable video player applied in the real time multimedia communication. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

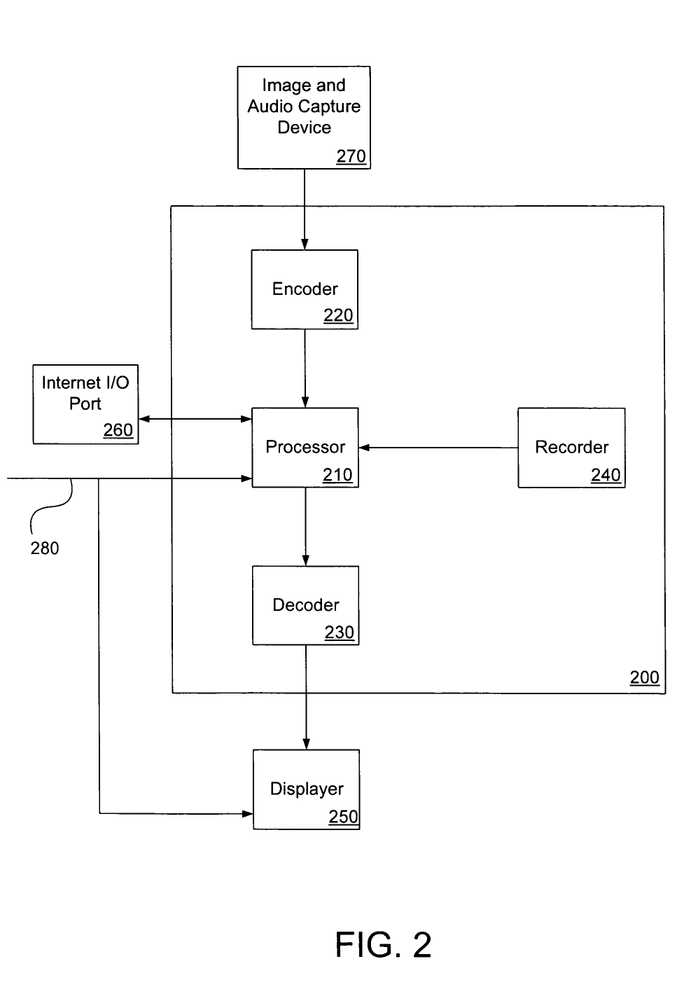

In the present invention, a recordable video player is designed to be applied in the real time multimedia communication, which will be detailed below and will demonstrate a superior performance than the conventional design as shown in FIG. 2.

Referred to FIG. 2, a block diagram of a recordable video player applied in the real time multimedia communication in accordance with the present invention is illustrated. The recordable video player applied in the real time multimedia communication comprises a processor 210—an encoder 220—a decoder 230—a recorder 240—a displayer 250—an internet I/O port 260—an image and audio capture device 270 and a AV (Audio-Video) transmission line 280.

Particularly, the recordable video player of the present invention utilizes an image and audio capture device and an internet I/O port to be applied in the real time multimedia communication. Wherein, the image and audio capture device 270 acts as a video camera which can capture the desired video immediately. The internet I/O port 260 is used to transmitted the data frames to the internet. Moreover, the packaged data frames are transmitted to the remote users by the Integrated Services Digital Network (ISDN)—Cable or Wireless Local Area Network (WLAN). On the other hand, the internet I/O port 260 can also be used to receive the data frames by ISDN—Cable or WLAN from the remote users.

As mentioned above, there are two operational modes while executing the real time multimedia communication: one is the transmitting mode and the other is the receiving mode. In the transmitting mode, the image and audio of the local users is captured by the image and audio capture device 270 and then is transmitted to the encoder. Wherein, the output encoded data string from the encoder 220 is the data format of MPEG2. The output encoded data string is converted to the data frame and transmitted to the internet I/O port 260 by the processor 210. Then, the data frames comprising the packaged output encoded data string can be transmitted to the remote users by ISDN—Cable or WLAN. Accordingly, the image and the audio of the local users is able to transmitted to the remote users by the recordable video player of the present invention.

Moreover, in the transmitting mode, the output encoded data string is not only transmitted to the internet I/O port 260 but also transmitted to the recorder 240 for recording by the processor 10 in the mean while. Wherein, the recorder 240 can be a DVD or VCD recorder—hard disk or memory. In this way, the content of the video conference can be recorded in the recorder 240.

Furthermore, the output encoded data string can also be transmitted to the decoder 230 by the processor 210. The decoder 230 would decode the output encoded data string into the displaying signal and then the displaying signal would be transmitted to the displayer 250. As a result, the local users can watch the image and audio of themselves in the displayer 250 by changing the displaying window.

There are usually two displaying windows in the video conference. One is the displaying window for showing the image and audio of the local users, and the other is the displaying window for showing the image and audio of the remote users.

In the receiving mode, the internet I/O port 260 receives the data frames converted from the input encoded data string of the remote users by ISDN—Cable or WLAN. Through the internet I/O port 260, the processor 210 can transmit the input encoded data string of the remote users to the decoder 230 and then the decoder 230 would decode the input encoded data string of the remote users into the displaying signal and then the displaying signal would be transmitted to the displayer 250. As a result, the image and audio of the remote users can be shown in the displayer 250.

Additionally, in the receiving mode, the input encoded data string is not only transmitted to decoder 230 but also transmitted to the recorder 240 for recording by the processor 10 in the mean while. Wherein, the recorder 240 can be a DVD or VCD recorder—hard disk or memory. In this way, the content of the video conference can be recorded in the recorder 240.

In this preferred embodiment of the present invention, the recordable video player of the present invention utilizes an image and audio capture device and an internet I/O port to be applied in the real time multimedia communication. For the popular use of the DVD or VCD recordable player, one can held a video conference at any time and any place even home if there is a DVD or VCD recordable player applied in the real time multimedia communication in accordance with the present invention.

Particularly, taking the advantage of the inherent encoder and decoder in the DVD or VCD recordable player, the additional encoding and decoding devices are no longer needed for the cost down in accordance with the present invention.

Moreover, the content of the video conference can be recorded simultaneously by using the DVD or VCD recordable player applied in the real time multimedia communication in accordance with the present invention.

While the present invention has been particularly shown and described with reference to a preferred embodiment, it will be understood by those skilled in the art that various changes in form and detail may be without departing from the spirit and scope of the present invention.

1. A recordable video player applied in real time multimedia communication, comprising:
an image and audio capture device for outputting a data string;
an encoder for encoding the data string to an output encoded data string;
an internet I/O port for transmitting the output encoded data string to an internet; and
a recorder for recording the output encoded data string selectively.

2. The recordable video player applied in real time multimedia communication according to claim 1, wherein the output encoded data string is the data format of MPEG 1, MPEG2 or MPEG4 and is transmitted to a remote user.

3. The recordable video player applied in real time multimedia communication according to claim 1, wherein the internet can be ISDN, Cable or WLAN.

4. The recordable video player applied in real time multimedia communication according to claim 1, wherein the recorder can be a DVD recorder, a VCD recorder, a hard disk or a memory.

5. The recordable video player applied in real time multimedia communication according to claim 1, further comprise a processor for transmitting the output encoded data to the internet I/O port or to the recorder.

6. A recordable video player applied in real time multimedia communication, comprising:
an internet I/O port for receiving an input encoded data string;
a decoder for decoding the input encoded data string to a displaying signal; and
a recorder for recording the input encoded data string selectively;

7. The recordable video player applied in real time multimedia communication according to claim 6, wherein the input encoded data string from a remote user is the data format of MPEG 1, MPEG2 or MPEG4.

8. The recordable video player applied in real time multimedia communication according to claim 6, wherein the internet I/O port receives the input encoded data string by ISDN, Cable or WLAN.

9. The recordable video player applied in real time multimedia communication according to claim 6, wherein the recorder can be a DVD recorder, a VCD recorder, a hard disk or a memory.

10. The recordable video player applied in real time multimedia communication according to claim 6, wherein the internet I/O port is connected to the decoder through a processor.

11. The recordable video player applied in real time multimedia communication according to claim 10, wherein the input encoded data is transmitted to the decoder by the processor.

12. The recordable video player applied in real time multimedia communication according to claim 6, wherein the decoder is connected to a displayer for displaying the displaying signal.

13. A recordable video player applied in real time multimedia communication, comprising an image and audio capture device, an encoder, an internet I/O port, a decoder and a recorder; wherein the real time multimedia communication comprise the steps of:
capturing an image and audio by an image and audio capture device;
encoding the data string of the captured image and audio to an output encoded data string by an encoder;
transmitting the output encoded data string to an internet and/or receiving an input encoded data string through an internet I/O port;
decoding the input encoded data string to a displaying signal by an decoder; and
recording the input encoded data string and/or the output encoded data string selectively by a recorder.

14. A method of the real time multimedia communication with a recordable video player according to claim 13, wherein the input encoded data string and the output encoded data are the data format of MPEG 1, MPEG2 or MPEG4.

15. A method of the real time multimedia communication with a recordable video player according to claim 13, wherein the output encoded data string is transmitted to a remote user, and the input encoded data string comes from the remote user.

16. A method of the real time multimedia communication with a recordable video player according to claim 13, wherein the output encoded data string is transmitted to the internet I/O port by a processor.

17. A method of the real time multimedia communication with a recordable video player according to claim 16, wherein the processor receives the input encoded data string and transmits the input encoded data string to the decoder.

18. A method of the real time multimedia communication with a recordable video player according to claim 16, wherein the processor can further transmit the input encoded data string and the output encoded data string to the recorder.

19. A method of the real time multimedia communication with a recordable video player according to claim 13, wherein the recorder can be a DVD recorder, a VCD recorder, a hard disk or a memory.

20. A method of the real time multimedia communication with a recordable video player according to claim 13, wherein the decoder is connected to a displayer for displaying the displaying signal.
